(19) United States
(12) Patent Application Publication
(10) Pub. No.: US 2007/0158395 A1
(43) Pub. Date: Jul. 12, 2007

(54) METHOD FOR PREPARING AND ASSEMBLING A SOLDERED SUBSTRATE

(75) Inventors: Benjamin V. Fasano, New Windsor, NY (US); Mario J. Interrante, New Paltz, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, ARMONK, NY (US)

(21) Appl. No.: 11/306,779

(22) Filed: Jan. 11, 2006

(51) Int. Cl. B23K 31/02

(52) U.S. Cl. 228/180.22

(57) ABSTRACT

A method to form solder microsockets on a first substrate (for example a chip carrier) so that when the first substrate is aligned with a second substrate having shaped solder elements (for example a semiconductor device), the shaped solder elements fit into the solder microsockets. At least one of the aligned solder elements and solder microsockets may be reflowed to effect joining of the first and second substrates.

### BACKGROUND OF THE INVENTION

The present invention relates generally to electronic packaging and, more particularly, relates to a method for preparing the electrical interconnections of a first substrate, for example a chip carrier, to a second substrate, for example a semiconductor device or chip (hereafter “semiconductor chip”).

Semiconductor chips (as well as inactive devices such as capacitors) can be connected to their supporting carrier by any number of interconnect methods. One particularly preferred method is called controlled collapse chip connection or simply “C-4”. In the C-4 method, small solder balls are formed on the input/outputs (I/Os) of the semiconductor chip. The semiconductor chip is joined to its supporting carrier to form a module by aligning the small solder balls on the semiconductor chip with corresponding pads (which may be coated with tin or solder) on the surface of the supporting carrier, followed by reflowing to cause bonding of the solder balls to the pads of the supporting carrier. The supporting carrier is typically made from a ceramic or organic material.

Once the semiconductor chip has been joined to the chip carrier, the chip carrier is usually joined to a second substrate, usually an organic card (may also be referred to as a printed wiring board or a motherboard), to form the second level of packaging. In one preferred method of joining, solder balls on the bottom of the chip carrier are joined to corresponding pads (which may also be coated with tin or solder) on the second substrate to form a ball grid array or simply “BGA”.

During the assembly of modules and BGAs, a number of factors affect the ability of the interconnects to be reliably formed which may include (but are not limited to) the solder connection type, the distortion of the adjacent contacts and contact height variations. With respect to the solder connection type, if a single melt solder is used (i.e., the entire solder connection on the first and second substrates becomes molten), one of the initially well aligned substrates may move with respect to the other substrate during the melting stage of the solder and self align to the other substrate, driven by the surface tension effects of a fully molten solder joint. There is greater difficulty establishing proper alignment with a dual melt solder (i.e., one of the solders on the first and second substrates melts at a higher temperature than the other solder on the first and second substrates) unless perfect placement and matching array pattern contact is established before and during solder melt.

The effect of the distortion of the adjacent contacts is especially apparent for large area or very fine pitch connections where the I/O pads or solder pads/balls may be slightly shifted from a perfect grid array.

Contact height variations, such as varying ball volumes, pretinned solder heights, substrate or device pad coplanarity or camber can occur during substrate manufacturing, solder pretinning or as a result of warping during thermal excursion such as reflow attach.

Each of the foregoing factors can have a significant impact on yield during the manufacturing process. Accordingly, it would be desirable to have a manufacturing process which takes the foregoing factors into account.

Brofman et al. U.S. Pat. No. 6,220,499, the disclosure of which is incorporated by reference herein, addresses camber and other surface irregularities by forming solder balls on a first substrate having camber or some other surface irregularity, planarizing those solder balls to form a planar surface and then joining the second substrate having solder balls to the first substrate.

Farooq et al. U.S. Pat. No. 6,541,305, the disclosure of which is incorporated by reference herein, addresses camber by causing the solder elements between two joined substrates to become elongated.

In view of the above, it is a purpose of the present invention to have an improved method for fabricating an electrical interconnection between two substrates having C-4 or BGA connections.

It is another purpose of the present invention to have an improved method for fabricating an electrical interconnection between two substrates having C-4 or BGA connections which accommodate the solder connection type, the distortion of the adjacent contacts and contact height variations.

It is another purpose of the present invention to have an improved method for fabricating an electrical interconnection between two substrates having C-4 or BGA connections which accommodate solders that soften or reflow at different temperatures, often encountered with lead-free and lead-containing solders.

These and other purposes of the present invention will become more apparent after referring to the following description of the invention considered in conjunction with the accompanying drawings.

### BRIEF SUMMARY OF THE INVENTION

The purposes of the invention have been achieved by providing according to a first aspect of the present invention a method for preparing and assembling a soldered substrate, the method comprising the steps of:

forming a quantity of solder on a substrate;

heating and reflowing the quantity of solder;

contacting the quantity of solder with a shaped article;

pressing the shaped article into the quantity of solder to form an indentation in the quantity of solder; and

removing the shaped article.

According to a second aspect of the invention, there is provided a method for preparing and assembling a soldered substrate, the method comprising the steps of:

forming a first quantity of solder on a first substrate;

heating and reflowing the first quantity of solder;

contacting the first quantity of solder with a shaped article;

pressing the shaped article into the first quantity of solder to form an indentation in the first quantity of solder;

removing the shaped article;

contacting the first quantity of solder with a second quantity of solder on a second substrate, the second quantity of solder being shaped so as to fit with the indentation in the first quantity of solder; and

heating the substrates so as to reflow at least one of the first and second quantities of solder.

According to a third aspect of the invention, there is provided a method for preparing and assembling a soldered substrate, the method comprising the steps of:

preparing a silicon wafer so as to have a plurality protrusions extending therefrom;

depositing a disc of solder on each of the protrusions with at least one protrusion extending into each of the discs of solder;

assembling the silicon wafer with a substrate having a plurality of vias therein so that the discs of solder contact the vias;

heating and reflowing the discs of solder so as to cause joining of the discs of solder to the vias;

cooling the discs of solder; and

removing the silicon wafer from the discs of solder so as to leave indentations in the discs of solder.

According to a fourth aspect of the invention, there is provided a method for preparing and assembling a soldered substrate, the method comprising the steps of:

preparing a silicon wafer so as to have a plurality protrusions extending therefrom;

depositing a disc of solder on each of the protrusions with at least one protrusion extending into each of the discs of solder;

assembling the silicon wafer with a first substrate having a plurality of vias therein so that the discs of solder contact the vias;

heating and reflowing the discs of solder so as to cause joining of the discs of solder to the vias;

cooling the discs of solder;

removing the silicon wafer from the discs of solder so as to leave indentations in the discs of solder;

contacting the discs of solder with solder elements on a second substrate, the solder elements being shaped so as to fit with the indentations in the discs of solder; and

heating the substrates so as to reflow at least one of the discs of solder and solder elements.

### BRIEF DESCRIPTION OF THE DRAWINGS

The features of the invention believed to be novel and the elements characteristic of the invention are set forth with particularity in the appended claims. The Figures are for illustration purposes only and are not drawn to scale. Although only a few connections are shown in each of the Figures, it should be understood that a full grid array of vias and connections are often used in practice. The invention itself, however, both as to organization and method of operation, may best be understood by reference to the detailed description which follows taken in conjunction with the accompanying drawings in which:

FIGS. 1A and 1B illustrate two substrates which are initially aligned and then become misregistered.

FIGS. 2A and 2B illustrate two substrates which form a nonplanar interconnect because of unequal solder volumes.

FIGS. 3A and 3B illustrate two substrates which are not completely aligned because at least one via is off center.

FIGS. 4A-4C illustrate the steps according to a first embodiment of the present invention to form microsockets to assist in the alignment and joining of two substrates.

FIGS. 5A and 5B illustrate alternative designs for the shaped element that forms the microsockets.

FIGS. 6A-6D illustrate the steps according to a second embodiment of the present invention to form microsockets to assist in the alignment and joining of two substrates.

### DETAILED DESCRIPTION OF THE INVENTION

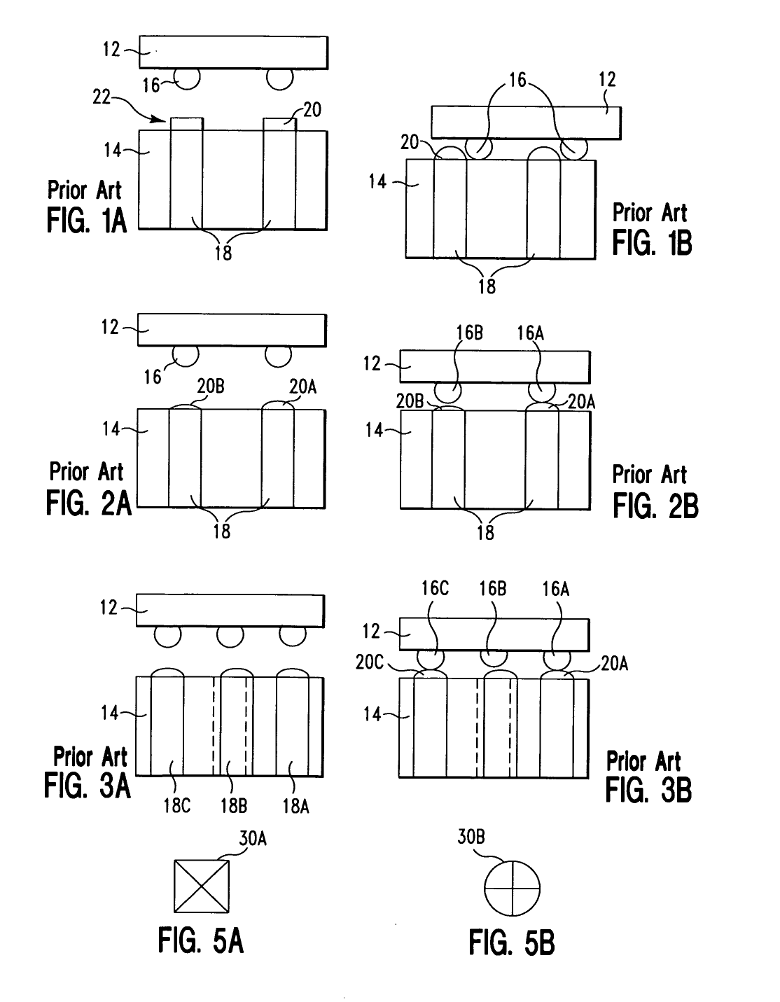

Referring to the Figures in more detail, and particularly referring to FIGS. 1A and 1B, there is shown first in FIG. 1A two substrates 12 and 14. Substrate 12, which may be for example a semiconductor chip, has solder balls 16 for joining with solder pads 20 at the end of vias 18 on substrate 14. Solder pads 20 have been flattened 22 in order to assist in the joining of substrate 12 and 14. FIG. 1B shows substrates 12 and 14 after heating to effect joining of substrates 12 and 14. As sometimes happens in practice, substrate 12 has “walked off” of substrate 14, leaving solder balls 16 and solder pads 20 misregistered and thus not connected.

FIG. 2A shows substrates 12 and 14 which are about ready to be heated and joined. However, the volume of solder for solder pad 20A is larger than the volume of solder for solder pad 20B on substrate 14 (and other solder pads (not shown) adjacent to solder pad 20B may also have larger solder volumes than solder pad 20B) so that when substrates 12 and 14 are heated and joined as shown in FIG. 2B, a nonplanar condition occurs. That is, because the volume of solder pad 20A is greater than the volume of solder pad 20B, solder pad 20A and solder ball 16A have joined but solder pad 20B and solder ball 16B have not joined, thereby creating a defect condition.

In FIG. 3A, substrate 14 has three vias 18A, 18B and 18C. Via 18B, however, is off center (i.e., out of position perhaps due to manufacturing tolerances or processing induced distortion) so that when substrates 12 and 14 are positioned and then heated and joined as shown in FIG. 3B, solder balls 16A and 16C join with solder pads 20A and 20C but solder ball 16B does not join with solder pads 20B, thereby creating a defect condition.

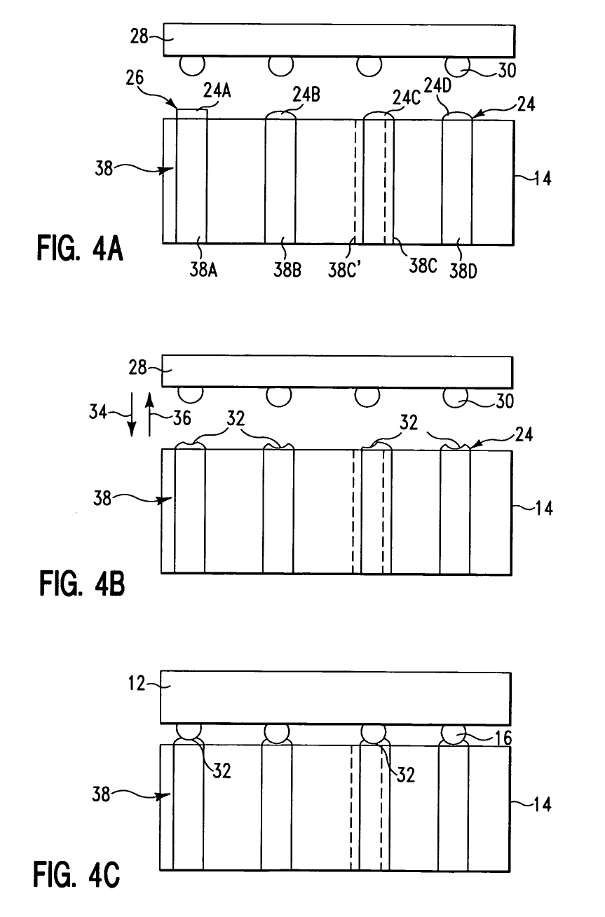

Referring now to FIGS. 4A to 4C, the method according to the invention will now be described. As noted previously, the prior art method of joining two substrates often led to defects due to factors such as the solder connection type, the distortion of the adjacent contacts and contact height variations. The present invention seeks to alleviate those factors, thereby leading to more consistent and defect-free joining of substrates.

Referring now to FIG. 4A, there is shown a substrate 14 which is to be joined to a second substrate 12 (shown in FIG. 4C). Each of the vias 38 has a quantity of solder, tin or other fusible material, hereafter collectively referred to as a solder material 24. Via 38A has solder material 24A which has been flattened 26 by means not important to the present invention. Via 38B has a low volume of solder material 24B while via 38D has a high volume of solder material 24D. Via 38C, having medium volume of solder material 24C, is misaligned from its correct position 38C′ due to manufacturing variances. The vias 38/solder material 24 as shown in FIG. 4A could be expected to lead to various nonplanar contact areas, misregistration and noncontact problems. The present inventors are proposing a press plate 28 having shaped elements 30 which are spaced very accurately (to within a few microns of a perfect grid) according to the specifications of the substrates to be joined. The press plate 28 and shaped elements 30 should be made from a hard nonsolder-wettable material to avoid lifting of the solder material 24 from the substrate 14 after the shaped elements 30 are pressed into the solder material 24. Preferred materials for the press plate 28 and shaped elements 30 include titanium, stainless steel, quartz and silicon, just to name a few. These materials can be coated with a non-wettable hard coating such titanium nitride or tantalum nitride to improve the release characteristics after solder shaping as described later. Again, the important characteristic of press plate 28 and particularly shaped elements 30 is that it be non-wettable by the solder. It is also possible for the press plate 28 and shaped elements 30 to be made of different materials provided that the material of the shaped elements 30 is non-wettable by the solder, the shaped elements 30 can be conveniently joined or attached to the press plate 28 and the shaped elements 30 and press plate 28 have similar thermal coefficients of expansion.

The shape of the shaped elements 30 shown in FIG. 4A is similar to that of solder balls but need not necessarily be so. The shaped elements may take on other shapes as needed to fit the particular joining situation. These other shapes may be a cone, pyramid, triangular, multi-faceted conical or multi-faceted semispherical. Shown in FIG. 5A is an example of shaped element 30A in the form of a pyramid while FIG. 5B is an example of shaped element 30B in the form of a multi-faceted semispherical shape.

The press plate 28 is accurately positioned with respect to substrate 14 by means not germane to the present invention. Referring now to FIG. 4B, the press plate 28 has been moved downwardly, as indicated by arrow 34, so as to cause shaped elements 30 to make contact with solder material 24 and form an indentation or microsocket 32 in each of solder material 24A, 24B, 24C and 24D. The press plate 28 and shaped elements 30 are then moved upwardly away from substrate 14 as indicated by arrow 36.

To facilitate the formation of the microsockets 32, it may be desirable to heat the solder material 24 (either locally or by heating the entire substrate 14) to a temperature above room temperature so as to soften the solder material 24. The temperature, however, should not be raised so high as to cause the solder material 24 to begin to liquefy. Alternatively, the shaped elements 30 may be warmed (either locally or by heating the entire press plate 28) to a temperature above room temperature but not so high as to cause the solder material 24 to liquefy upon contact between the shaped elements 30 and solder material 24. As another alternative, both the solder material 24 and shaped elements 30 may be warmed to a temperature above room temperature but not so high as to cause the solder material 24 to liquefy upon contact between the shaped elements 30 and solder material 24.

The press plate 28 and shaped elements 30 are now moved away from the substrate 14 and replaced with substrate 12 having solder elements 16 (usually solder balls) to be joined to solder material 24 of substrate 14.

Substrate 12 is accurately positioned with respect to substrate 14 and then they are brought into contact. Solder elements 16 are then received by microsockets 32 in the solder material 24. As can be appreciated the engagement of solder elements 16 and microsockets 32 cause the accurate registration of each solder element 16 with respect to each of the solder material 24A, 24B, 24C and 24D. The substrates 14, 12 may now be heated in a conventional manner to cause joining of the solder elements 16 to the solder material 24. Because of the engagement of the solder elements 16 and solder material 24, the problems heretofore found by those skilled in the art, such as nonplanar contact areas, misregistration and noncontact between solder elements, are now alleviated.

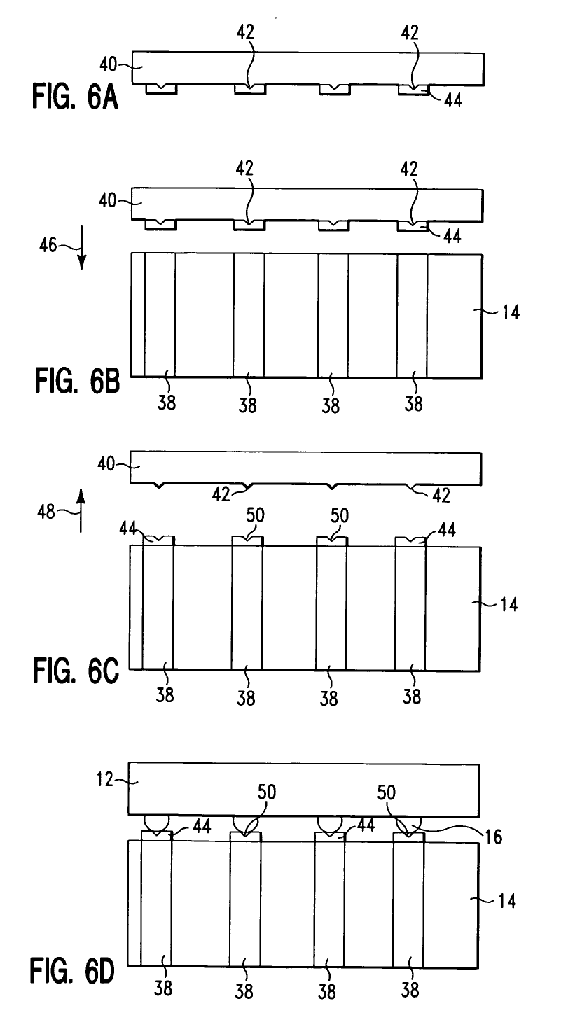

A second embodiment of the invention will be discussed with respect to FIGS. 6A to 6D. Referring first to FIG. 6A, a silicon wafer 40 is specially prepared by patterned etching (for instance, using a reactive ion etching process with, for example CF₄, or chemical etchants such as HF-based aqueous formulations) to form protrusions 42. These may be any shape that is conveniently etched into the silicon and may include cone, pyramid or triangular shapes, just to name a few. Thereafter, solder material 44 is deposited onto the silicon wafer 40 as shown in FIG. 6A to form discs of solder material 44. One method of depositing such solder material 44 is by evaporating solder material through a molybdenum mask.

Thereafter, silicon wafer 40 having the discs of solder material 44 is aligned with substrate 14 so that discs of solder material 44 are aligned with vias 38 of substrate 14 as shown in FIG. 6B. Silicon wafer 40 is lowered, indicated by arrow 46, into contact with substrate 14 so that discs of solder material 44 contact vias 38. While still maintaining contact, the silicon wafer 40, discs of solder material 44 and substrate 14 are heated to cause reflow of solder material 44. The assembled silicon wafer 40, discs of solder material 44 and substrate 14 are then cooled to room temperature. A weight may be applied to the silicon backside during reflow to provide additional force on the protrusions pressing into the solder discs 44 to prevent the protrusions 42 and silicon wafer 40 from “floating” off the solder material 44 by surface tension of the molten solder.

Referring now to FIG. 6C, the silicon wafer 40 is removed, indicated by arrow 48, from the substrate 14. As the silicon wafer 40 and protrusions 42 not wettable by molten solder, the discs of solder material 44 will remain adhered to vias 38 of substrate 14. Importantly, the discs of solder 44 will have indentations or microsockets 50 formed therein.

Lastly, substrate 12 having solder elements 16 is brought into contact with discs of solder material 44. Solder elements 16 will engage with microsockets 50 as shown in FIG. 6D. As in the previous embodiment, the engagement of solder elements 16 and microsockets 50 cause the accurate registration of each solder element 16 with respect to each disc of solder material 44. The substrates 1, 12 may now be heated in a conventional manner to cause joining of the solder elements 16 to the discs of solder material 44.

Substrates 14 and 12 may be any of a semiconductor chip, capacitor (or any other inactive device), chip carrier, card, printed wiring board, motherboard and combinations thereof. For example, substrate 12 may be a semiconductor chip while substrate 14 may be a chip carrier. As another example, substrate 12 may be a chip carrier while substrate 14 may be a card, printed wiring board or motherboard.

Solder material 24 and solder elements 16 may be any fusible material that is conventionally used for joining two substrates. These include tin, lead/tin solders, lead-free solders and the like. The fusible material may be a single melt system in which the fusible material for solder material 24 and solder elements 16 have similar melting points or melting ranges so that the entire solder connection becomes molten. Alternatively, the fusible material may be a dual melt system where only one of the solder material 24 and solder elements 16 is molten during joining.

It will be apparent to those skilled in the art having regard to this disclosure that other modifications of this invention beyond those embodiments specifically described here may be made without departing from the spirit of the invention. Accordingly, such modifications are considered within the scope of the invention as limited solely by the appended claims.

What is claimed is:

1. A method for preparing and assembling a soldered substrate, the method comprising the steps of:
forming a quantity of solder on a substrate;
heating and reflowing the quantity of solder;
contacting the quantity of solder with a shaped article;
pressing the shaped article into the quantity of solder to form an indentation in the quantity of solder; and
removing the shaped article.

2. The method of claim 1 wherein during the step of pressing the shaped article, the quantity of solder is warmed to a temperature which is above room temperature but less than that at which the quantity of solder begins to melt.

3. The method of claim 1 in which the shaped article is warmed to a temperature which is above room temperature but less than that at which the quantity of solder begins to melt.

4. The method of claim 3 wherein the shaped article is nonwetting with respect to the quantity of solder.

5. The method of claim 1 wherein the substrate is a chip carrier.

6. The method of claim 1 wherein the substrate is a card, printed wiring board or motherboard.

7. The method of claim 1 wherein the quantity of solder is a lead-free or lead-containing solder.

8. The method of claim 1 wherein the substrate comprises a plurality of vias intersecting with a surface of the substrate and the quantity of solder comprises a quantity of solder on each of the plurality of vias.

9. A method for preparing and assembling a soldered substrate, the method comprising the steps of:
forming a first quantity of solder on a first substrate;
heating and reflowing the first quantity of solder;
contacting the first quantity of solder with a shaped article;
pressing the shaped article into the first quantity of solder to form an indentation in the first quantity of solder;
removing the shaped article;
contacting the first quantity of solder with a second quantity of solder on a second substrate, the second quantity of solder being shaped so as to fit with the indentation in the first quantity of solder; and
heating the substrates so as to reflow at least one of the first and second quantities of solder.

10. The method of claim 9 wherein during the step of pressing the shaped article, the first quantity of solder is warmed to a temperature which is above room temperature but less than that at which the first quantity of solder begins to melt.

11. The method of claim 9 in which the shaped article is warmed to a temperature which is above room temperature but less than that at which the first quantity of solder begins to melt.

12. The method of claim 11 wherein the shaped article is nonwetting with respect to the first quantity of solder.

13. The method of claim 9 wherein the first substrate is a chip carrier and the second substrate is a semiconductor device or a capacitor.

14. The method of claim 9 wherein the first substrate is a card, printed wiring board or motherboard and the second substrate is a chip carrier.

15. The method of claim 9 wherein the first and second quantities of solder comprise a lead-free or lead-containing solder.

16. The method of claim 9 wherein the first and second quantities of solder form a single melt solder system.

17. The method of claim 9 wherein the first and second quantities of solder form a dual melt solder system.

18. The method of claim 9 wherein the first substrate comprises a plurality of vias intersecting with a surface of the first substrate and the first quantity of solder comprises a quantity of solder on each of the plurality of vias.

19. A method for preparing and assembling a soldered substrate, the method comprising the steps of:
preparing a silicon wafer so as to have a plurality protrusions extending therefrom;
depositing a disc of solder on each of the protrusions with at least one protrusion extending into each of the discs of solder;
assembling the silicon wafer with a substrate having a plurality of vias therein so that the discs of solder contact the vias;
heating and reflowing the discs of solder so as to cause joining of the discs of solder to the vias;
cooling the discs of solder; and
removing the silicon wafer from the discs of solder so as to leave indentations in the discs of solder.

20. A method for preparing and assembling a soldered substrate, the method comprising the steps of:
preparing a silicon wafer so as to have a plurality protrusions extending therefrom;
depositing a disc of solder on each of the protrusions with at least one protrusion extending into each of the discs of solder;
assembling the silicon wafer with a first substrate having a plurality of vias therein so that the discs of solder contact the vias;
heating and reflowing the discs of solder so as to cause joining of the discs of solder to the vias;
cooling the discs of solder;
removing the silicon wafer from the discs of solder so as to leave indentations in the discs of solder;
contacting the discs of solder with solder elements on a second substrate, the solder elements being shaped so as to fit with the indentations in the discs of solder; and
heating the substrates so as to reflow at least one of the discs of solder and solder elements.
